(19) United States
(12) Patent Application Publication
(10) Pub. No.: US 2014/0007343 A1
(43) Pub. Date: Jan. 9, 2014

(54) METHOD OF TRANSFERRING A PATIENT TO A JET

(71) Applicant: Woodlark Circle, Inc., Bethlehem, PA (US)

(72) Inventor: David T. Davis, Bethlehem, PA (US)

(21) Appl. No.: 13/932,386

(22) Filed: Jul. 1, 2013

Related U.S. Application Data
(60) Provisional application No. 61/667,608, filed on Jul. 3, 2012.

(51) Int. Cl. A61G 7/10

(52) U.S. Cl. CPC A61G 7/1021
USPC 5/83.1

(57) ABSTRACT

A pneumatic lift and method of using the pneumatic lift including at least three jacking-mattresses stacked one atop another and arranged in air flow communication with one another. At least one of the jacking-mattresses is also arranged in air flow communication with a source of pressurized air.

### CROSS REFERENCE TO RELATED APPLICATIONS

This application is a non-provisional of and claims priority to U.S. Provisional Patent Application Ser. No. 61/667,608, filed Jul. 3, 2013, which is pending.

### FIELD OF THE INVENTION

The present invention generally relates to a method suitable for lifting patients and, more particularly, to a pneumatic lift suitable for use in vertically moving living creatures.

### BACKGROUND OF THE INVENTION

There is a need for a compact, lightweight and easily portable patient lifting device, and a method for using, to assist caregivers and emergency personnel in lifting prone patients from a lower position, e.g., the floor, to a relatively higher position, e.g., a bed, table, gurney, vehicle, or jet, etc.; for use in the home, in institutional settings, and in the outside world. Transferring of disabled patients is a leading cause of injury in the health-care industry, with the nursing occupation having among the highest incidence of back injury, despite the prior art and the availability of commercial patient lifts. These lifts are under-utilized for a number of reasons, such as restricted space in many hospital wards and bathrooms, cumbersome operating requirements, the indignity involved in the mode of transport, the additional time required for performing the transfer, and the unavailability of the lift at both the patient's starting and destination locations. In addition, many patients are essentially home-bound due to the unavailability of a conveniently portable lift, reducing their quality of life unnecessarily. A method and device is needed in the art that is simple to set up and use, feels safe, secure and is not intimidating for the patient, and wherein the lifting device can be transported with the patient on a jet, vehicle, or the like.

This problem is pervasive in the home health care industry as well, where spaces are not designed for safe patient transfers, and the caregiver is often alone and has no help during lifts. Since conventional lifts are available in less than ten percent of the homes visited by home health care professionals, a method and device that can be easily implemented and brought from home to home is also required. In addition, most prior art lifting devices do not provide for the reduction of hip and back deflection during lifting. This is a significant problem because if a person's hip or back is already injured, such uncontrolled deflections could exacerbate the existing condition, or possibly cause additional injury.

While this field contains considerable prior art, these devices have proven to be inadequate. For example, U.S. Pat. No. 4,805,248, issued to Lunau is typical of ceiling-mounted patient lifts. While effective, these are limited to use in very well defined areas. The ceiling mounted patient lifts also require the patient to bend, which is not always an option. U.S. Pat. No. 3,137,011, issued to Fischer is representative of a common type of mobile patient lift. A major disadvantage of this design is that the patients are essentially suspended from a hook. The resultant swaying motion during transfer is disconcerting to most patients. In addition, the patient is transported in a partially reclined position, increasing their sense of helplessness and indignity, particularly if used outside in public.

U.S. Pat. No. 3,914,808, issued to Woods teaches the use of a short flexible sling in a front-loading orientation, with a pivoting column. The base must be relatively wide in order to avoid tipping as the column is rotated, and there is no means for compactly transporting or storing the lift. Additionally, the use of a fixed length sling requires that the patient be sitting precisely on the center of the sling, to avoid tipping the patient as the column is raised. This increases the time and training required to use the lift.

Pneumatically inflatable, and hydraulically expandable lifting bags are also known. For example, DE-U-1,897,870 discloses an extendable or inflatable lifting device having a pressure release valve assembly. U.S. Pat. No. 3,695,582, issued to Clay discloses a lifting jack for motor vehicles which uses fluid pressure for operating power to raise the wheel of a vehicle. The jack relies upon a pair of stacked hollow flexible plastic bags that may be filled with a suitable fluid.

In U.S. Pat. No. 5,606,785, issued to Shelberg et al., an inflatable air mattress positioner is provided for use with a casket, coffin or alternative container. The assembly includes a partially pneumatic pillow with a chamber in which is disposed a plurality of air chambers, each one of which has a corresponding air tube and valve assembly. A cushion coacts with the air bladders to position the head, upper arm, chest and shoulder region of a cadaver so that the cadaver chin is disposed in an acceptable proper height in relation with the chest. The assembly includes an inflatable air mattress having a plurality of air chambers which are independently inflatable to position a cadaver at an appropriate height and angle in the casket. Additional separate independent air bladders are also provided to be disposed under the cadaver to aid in positioning the cadaver and tilt the cadaver along its longitudinal axis for mourner viewing as well as positioning the back, arms, head, neck or any other part of the cadaver that requires adjustment.

In the U.S. Pat. Nos. 4,688,760, 4,786,032, 4,993,736, 5,651,149, and 5,669,086, all issued to Garmen et al., a variety of lifting devices are provided that include a base, a platform disposed above the base, a thrust mechanism positioned between the platform and the base to lift the platform with respect to the base. Garmen et al. often choose a pneumatic thrust mechanism in the form of stacked bellows including a flexible wall composed of substantially inelastic material and having a vertically spaced horizontal stiffener. The bellows include an inlet to allow a gaseous material to inflate each bag for applying lifting forces to the platform. U.S. Pat. No. 6,199,827, issued to Rimington, et al., also discloses an extendable or inflatable lifting device

None of the foregoing patents adequately address the problem of insuring that a lift is available at both a patient's starting and final locations. Patient transfer mattresses are also well known in the art which include at least two flexible material sheets, that together define a plenum chamber, with at least one sheet being completely perforated with small pinholes over its surface area, and which open up directly to the interior of the plenum chamber. Such prior art mattresses are used by arranging the perforated sheet so that it faces an underlying fixed, generally planar support surface, such as a floor or table. When the mattress is charged with pressurized air, the escape of air under pressure through the pinholes acts initially to jack a load placed upon the mattress (i.e., to lift the load in increments) and thereby creates an air bearing of relatively small height between the underlying fixed, generally planar support surface and the perforated flexible sheet.

For example, in U.S. Pat. No. 4,517,690, issued to Wegener, an air pallet is disclosed that is formed from upper and lower thin flexible film sheets sealed at their edges to form a plenum chamber. Wegener's air pallet functions to move a load with minimal friction over an underlying generally planar fixed support surface. The bottom thin flexible material sheet is perforated by small diameter perforations such as pin holes.

In U.S. Pat. No. 4,417,639, issued to Wegener, a pair of relatively rigid planar members are arranged overlying each other, and are coupled about their edges by a flexible film band to form a jacking plenum chamber. The upper planar member functions as the load support, having a gas inlet hole adjacent one edge. Gas under pressure enters an end of the jacking plenum chamber and escapes through the outer end which allows for jacking of the load. Wegener's design is only capable of jacking the load, e.g., a patient lying on the mattress, several inches above the underlying support surface.

### SUMMARY OF THE INVENTION

The present invention provides, in its broadest aspects, a method for use of a pneumatic lift including at least two jacking-mattresses stacked one atop another, where the jacking-mattresses may be arranged in air flow communication with one another.

In one embodiment of the invention, a method for implementing a pneumatic lift is provided to transfer a patient to a transportation device. If the process can be completed without performing a specific step, then a step may be omitted from the process as necessary, and desired by the operators. The process may be implemented, not only to transport an individual patient, but also heavy objects and the like. Generally, a patient or heavy object is provided. A jet, vehicle, bed, table or gurney is provided in close proximity to the patient. If a jet is utilized, the jet will often have a ledge or other similar structure that extends horizontally from an open door. The patient is placed on top of an inflatable pneumatic lift. The inflatable pneumatic lift is preferably substantially deflated at this point in the process. The patient is then secured to the pneumatic lift, which can either be done through the use of straps or by ensuring the patient is placed directly in the center of the pneumatic lift. At least one valve of the pneumatic lift is then opened to allow air to flow into the pneumatic lift. The pneumatic lift is then inflated by flowing pressurized air through the open valve. In the preferred embodiment utilizing the transportation device of a jet, this raises the pneumatic lift vertically to be substantially parallel with the horizontally extending ledge. Then an operator shuts off the flow of air to pneumatic lift when lower portion of individual and/or bedding under patient is substantially parallel with the upper surface of horizontally extending ledge. The air valve is then closed to ensure the pneumatic lift remains at a constant height.

The individual is then shifted horizontally from pneumatic lift to the horizontal ledge extending from the open door of the jet. The individual is then delivered fully into the jet, keeping the individual substantially parallel to the ground at all times. This shifting process can be performed in a number of ways. For instance, the patient may be pushed or the horizontally extending ledge may extend out away from the jet to slide under the patient laying on the pneumatic lift and then fully slide the patient into the jet. The process then includes deflating the pneumatic lift. Then the operator may decrease the volume and surface area of the pneumatic lift by folding, rolling, crimping, creasing, or any other method to decrease the amount of space the pneumatic lift takes up while being stored. The pneumatic lift is then placed inside the jet and the door of the jet is closed.

When the individual exits the jet, the process is performed in a reverse manner. More particularly, after re-opening the door of the jet, the fully deflated pneumatic lift is removed from the jet. The deflated pneumatic lift is placed in close proximity to the jet and is then inflated by supplying a flow of pressurized air to pneumatic lift through an open valve. The pneumatic lift is raised vertically to be substantially parallel with horizontal extending ledge by supplying flow of air to open valve. The flow of air is then shut off when the upper surface of the pneumatic lift is substantially parallel with horizontal extending ledge. The air source is removed and the air valve is closed to ensure no air exits the pneumatic lift and that the pneumatic lift remains at a constant height. The individual is then shifted horizontally from horizontal ledge extending from the open door of the jet to the upper surface of the pneumatic lift. The shifting of the individual may be implemented by sliding, rolling, lifting, pushing, or any known method to move the patient onto the upper surface of the pneumatic lift.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is an end on perspective view of a pneumatic lift formed in accordance with the present invention;

FIG. 2 is another end on perspective view of the pneumatic lift shown in FIG. 1;

FIG. 3 is a partially broken-away, perspective view of a jacking-mattress formed in accordance with the present invention;

FIG. 4 is a broken-away perspective view of a corner portion of the jacking-mattress shown in FIG. 3;

FIG. 5 is a broken-away perspective view of a corner portion of an alternative jacking-mattress having scalloped edged baffle-panels;

FIG. 6 is a broken-away, cross-sectional view of the jacking-mattress having scalloped edged baffle-panels shown in FIG. 5;

FIG. 7 is a perspective view of a typical situation where the present invention will be implemented;

FIG. 8 is a perspective view of a patient on an emergency transport stretcher adjacent to the pneumatic lift as shown in FIG. 1;

FIG. 9 is a perspective view of a patient laying on a pad on a top surface of the pneumatic lift as shown in FIG. 1;

FIG. 10 is a perspective view of a jet having a horizontally extending ledge parallel to the ground, as implemented in the present invention;

FIG. 11 is a side view of the implementation of the method of the present invention, showing a patient laying on the pneumatic lift in close proximity to a jet;

FIG. 12 is a side view of the implementation of the method of the present invention, showing a patient having been raised to be laying parallel to the ledge extending horizontally from the open door of the jet;

FIG. 13 is a side view of the implementation of the method of the present invention, showing the patient being shifted from the pneumatic lift into the plane;

FIG. 14 is a perspective view of placing the pneumatic lift and ledge inside of the jet;

FIG. 15 is a flow chart portraying steps of the present invention.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses are intended to cover the structures described, suggested, or rendered obvious by the written description or drawings for performing the recited function, including not only structural equivalents but also equivalent structures.

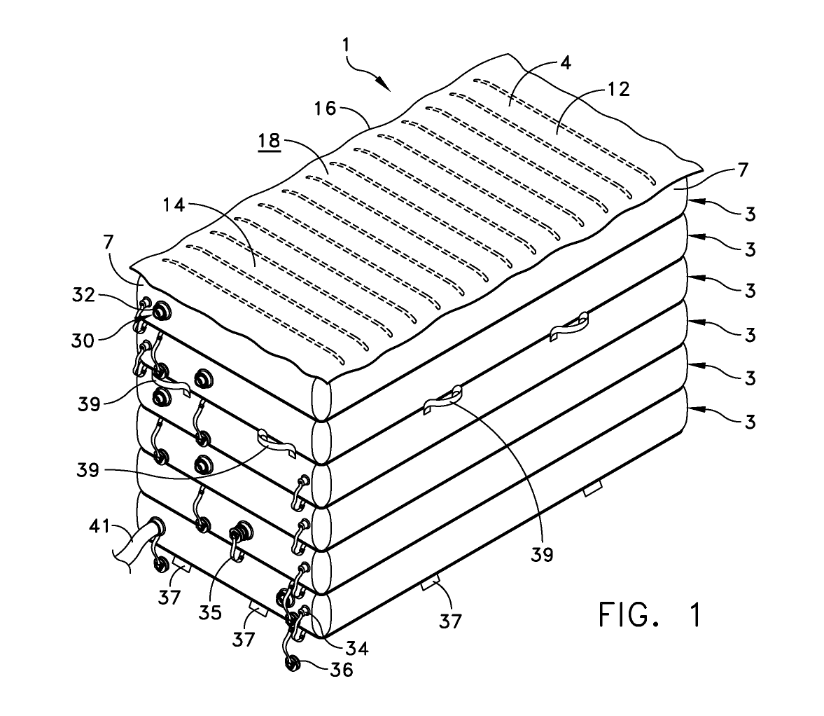

Referring to FIGS. 1-4, a pneumatic lift 1 formed in accordance with one embodiment of the present invention comprises a plurality of jacking-mattresses 3 that are stacked and secured together, one atop another. Each jacking-mattress 3 includes a top panel 4, a bottom panel 6, a perimeter band 7, and a plurality of internally disposed, transverse baffle-panels 8. More particularly, top panel 4 comprises a head portion 12, a foot portion 14, and a peripheral edge 16, and is formed from a sheet of nylon scrim or the like, that is coated on at least its outer surface 18 with a water proof coating. The inner surface of top panel 4 may also be coated with a water proof coating as well. Water proof coatings that may be used in connection with the invention include any of the well known polymeric or elastomeric compounds that are known to be impervious to semi-solids and liquids, such as, blood, urine, feces, hospital strength disinfecting compounds, alcohol, or the like.

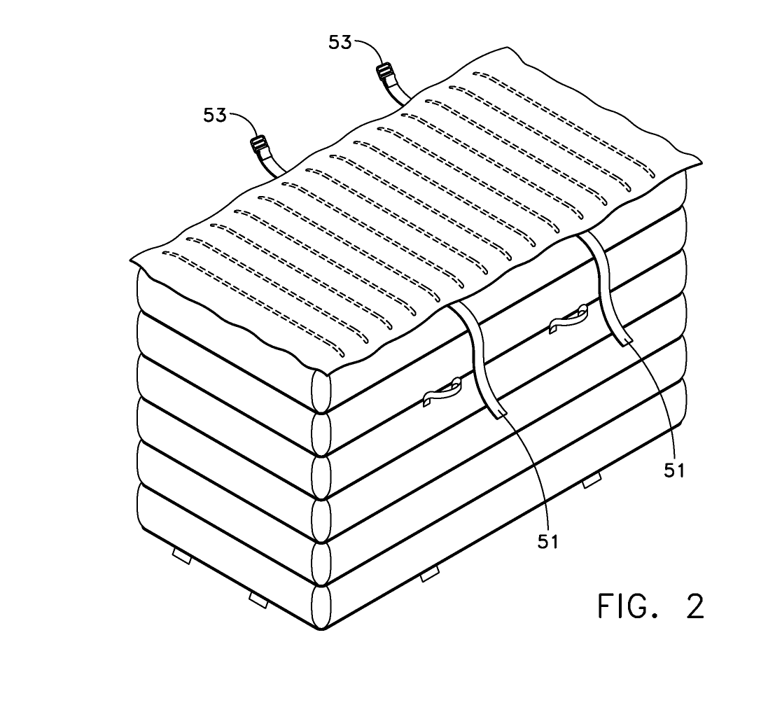

Bottom panel 6 comprises a head portion 22, a foot portion 24, and a peripheral edge 26, and is also formed from a sheet of nylon scrim or the like, that may also be coated on at least its outer surface with a water proof coating. Inner surface 29 of bottom panel 6 may also be coated with a water proof coating as well. Perimeter band 7 extends between peripheral edges 16 and 26, and circumferentially around top panel 4 and bottom panel 6, so as to enclose a central chamber 27 and thereby form each jacking-mattress 3. Through-bores 30 are defined in the portions of perimeter band 7 that lie between head portions 12 and foot portions 14. Peripheral edges 16 and 26 may have fastening means attached to them, such as a conventional zipper mechanism, snaps, or the like. A plurality of inlet/outlet fixtures 32 are positioned within through-bores 30 in the central portion of perimeter band 7. Each inlet/outlet fixture 32 is sealingly positioned therethrough so as to controllably communicate with central chamber 27 of jacking-mattress 3. One or more of inlet/outlet fixtures 32 may be a closable opening or a valve 34 that sealingly accepts an air supply hose 41 from a source of flowing pressurized air of the type well known in the art. Each closable opening or valve 34 may have attached thereto a release string 35. Release string 35 is attached to ensure cover 36 of valve 34 does not fall off during the process of using the pneumatic lift 1 and get lost. One or more jacking mattresses 3 may have one or more handles 39 fixedly attached to its outer surface. Handles 39 may be made of any sort of combination of polymers, rope, nylon, or the like. The bottom surface of the lower-most jacking mattress 3 has attached thereto several tabs 37. Tabs 37 provide additional support to keep pneumatic lift 1 stable. As shown in FIG. 2, pneumatic lift 1 may include a plurality of straps 51 and corresponding buckles 53. Straps 51 are optionally set in place and utilized to secure patient 54 to pneumatic lift 1.

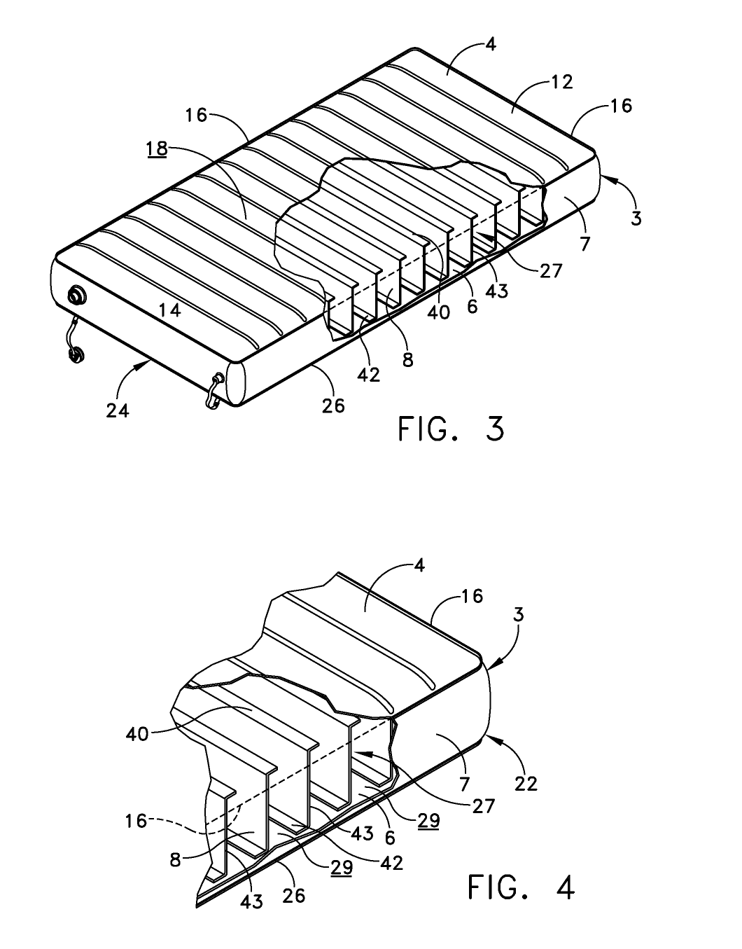

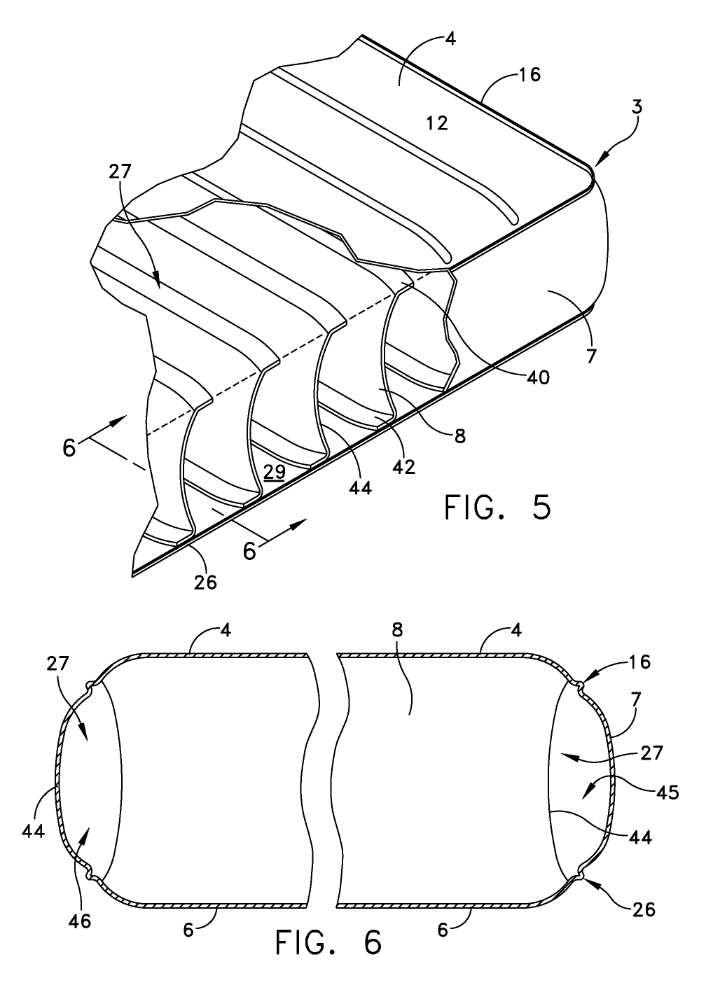

Referring to FIGS. 3-6, plurality of baffle-panels 8 each comprise substantially rectangular sheets of nylon scrim or the like, and include a top edge 40, a bottom edge 42, and end edges 44. Baffle-panels 8 may have differing widths depending on their position within jacking-mattress 3. Each top edge 40 is fastened transversely to a portion of the inner surface of top panel 4, and each bottom edge 42 is fastened transversely to a portion of inner surface 29 of bottom panel 6. End edges 44 are arranged in spaced relation to the inner facing surface of longitudinally extending portions of perimeter band 7 (FIGS. 3-6), so as to define a pair of longitudinally oriented air flow channels 45 and 46 within each jacking-mattress 3. In one embodiment, a curved or scalloped end edge 44 (FIGS. 5 and 6) may be employed to increase the size of air flow channels 45 and 46.

A pneumatic lift 1 is assembled according to the present invention in the following manner. Two, three, four, or more jacking-mattresses 3 are each individually assembled by laying out a bottom panel 6 on a suitable support surface 68 so that baffle-panels 8 may be transversely arranged along the length of inner surface 29. Once in this position, bottom edge 42 of each baffle-panel 8 is fixedly fastened to inner surface 29 of bottom panel 6. Each baffle-panel 8 is often heat sealed along the interface between bottom edge 42 and inner surface 29 of bottom panel 6. This heat sealing may be done with the application of heat or ultrasonic energy at the interface between bottom edge 42 and inner surface 29. Once a plurality of baffle-panels 8 are fastened to inner surface 29 of bottom panel 6, top panel 4 is arranged in overlying confronting relation to bottom panel 6 so that head portion 12 of top panel 4 is confronting head portion 22 of bottom panel 6 and foot portion 14 of top panel 4 is confronting foot portion 24 of bottom panel 6. Once in this position, each top edge 40 of each baffle-panel 8 is fixedly fastened to the inner surface of top panel 4. In order to complete construction of each jacking-mattress 3, it is necessary to sealingly fasten peripheral edge 16 of top panel 4 and peripheral edge 26 of bottom panel 6 to corresponding edges of perimeter band 7. In one embodiment, conventional zipper mechanisms are fastened to peripheral edges 16 and 26 so that several jacking-mattresses 3 may be stacked, one upon another, and releaseably secured to one another by zippers. Alternatively, jacking-mattresses 3 may be held in a stack by heat sealing their respective peripheral edges 16,26 or by other fastening techniques. In one embodiment, a plurality of air conduits 50 are assembled to the plurality of jacking-mattresses 3 so as to interconnect through-bores 30 of adjacent jacking-mattresses 3 in air flow communication, via inlet/outlet fixtures 32.

Pneumatic lift 1 is operated in the following manner. An object to be lifted, e.g., a human being, is placed atop outer surface 18 of top most jacking-mattress 3, while pneumatic lift 1 is in a fully or partially deflated state. It will be understood by fully deflated that little or no air will be present in central chambers 27 of each of the stacked jacking-mattresses 3 making up the pneumatic lift. Once the object is in position, high pressure air (e.g., at or around 2.8 psi or between 75 and 100 cubic feet per minute of air flow) is introduced through air supply hose 41 which is interconnected in air flow communication with valve 34. Although not a requirement of the invention, air supply hose 41 is preferably engaged with valve 34 in the lower most jacking-mattress 3 in the stack forming pneumatic lift 1. As air enters central chamber 27 of the first jacking-mattress 3, it flows through air flow channels 45, and thereby between each of baffle-panels 8 so as to inflate this first jacking-mattress 3. In one embodiment, each individual jacking mattress 3 is separately and often sequentially filled with pressurized air via that jacking-mattress' 3 own valve 34 (FIGS. 1-6). In another embodiment, each jacking-mattress 3 is in air communication with each other, and therefore the filling of valve 34 with pressurized air will fill each jacking-mattress 3 in fluid communication with each other. This air filling process continues until each of jacking-mattresses 3 are sufficiently filled with pressurized air. It will be understood that a maximum achievable height of the fully inflated pneumatic lift 1 will be determined by the number of jacking-mattresses 3 that have been stacked one atop the other. In order to lower an object, it is simply necessary to open one or more inlet/outlets 32 so as to allow the pressurized air to flow outwardly thereby deflating pneumatic lift 1.

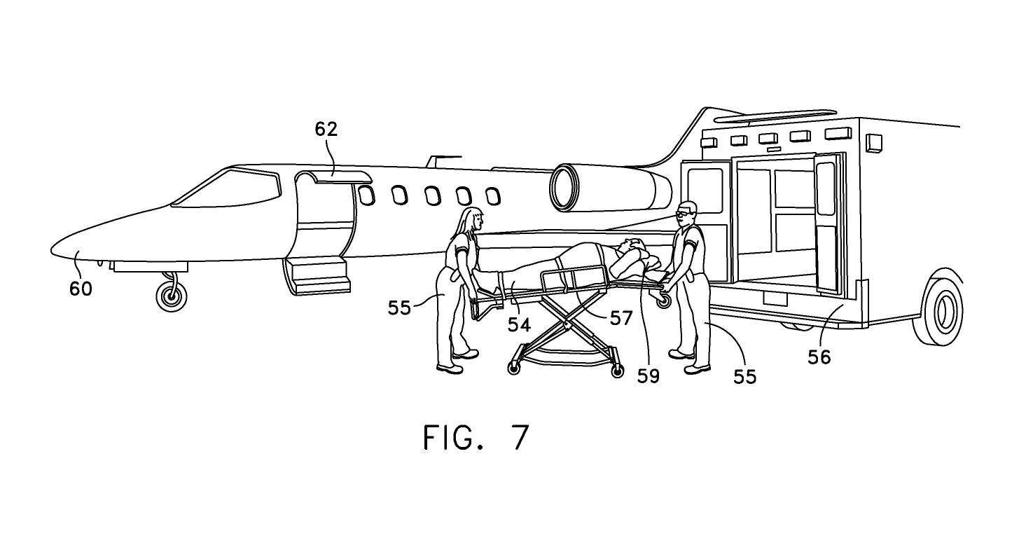

FIG. 7 is a perspective view of a typical situation where the present invention may be implemented. Operators 55 have been given the task of moving patient 54 from ambulance 56, to stretcher 57, and finally into jet 60. In the preferred embodiment, patient 54 is laying on pad 59 located on stretcher 57. Operators 55 may be any hospital personnel, or even an ordinary caregiver who has been given the task in an emergency. Stretcher 57 may be any surface such as a table, bed, the ground, or any other surface patient 54 may happen to be laying on. Door 62 of jet 60 is preferably open prior to starting the process of moving patient 54 from surface 57 to jet 60.

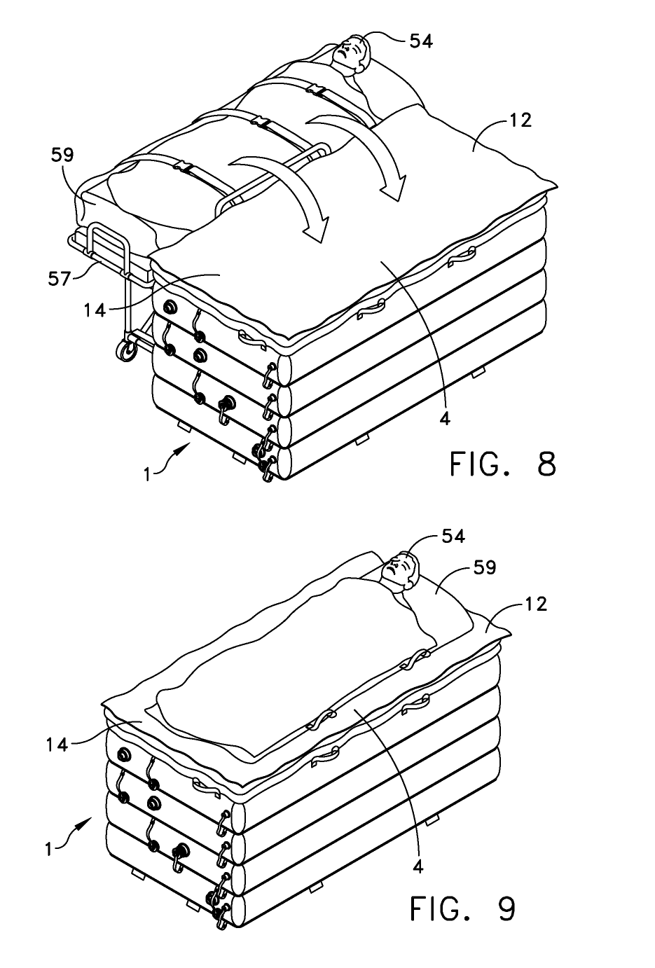

FIGS. 8 and 9 show a perspective view of patient 54 on an emergency transport stretcher 57 adjacent to pneumatic lift 1 and on pneumatic lift 1. Patient 54 is moved from stretcher 57 to pneumatic lift 1 by operators 55. Patient 54 is preferably moved onto upper surface pad 4 of pneumatic lift 1 while being attached to emergency pad 59, but the process is not limited to this implementation as patient 54 may be moved in the absence of pad 59. Patient's 54 head is preferably moved to head portion 12 of pneumatic lift 1 and patient's 54 feet are preferably moved to foot portion 14 of pneumatic lift 1. FIG. 8 shows patient 54 laying on stretcher 57 adjacent to pneumatic lift 1. FIG. 9 shows patient 54 after being moved from adjacent to pneumatic lift 1 to laying atop upper surface pad 4 of pneumatic lift 1. As shown in the preferred embodiment, patient 54 is moved along with emergency pad 59. Being moved with pad 59 allows patient 54 to remain in a flat laying position without being bent or twisted in any way during the move from stretcher 57 to top surface 4 of pneumatic lift 1.

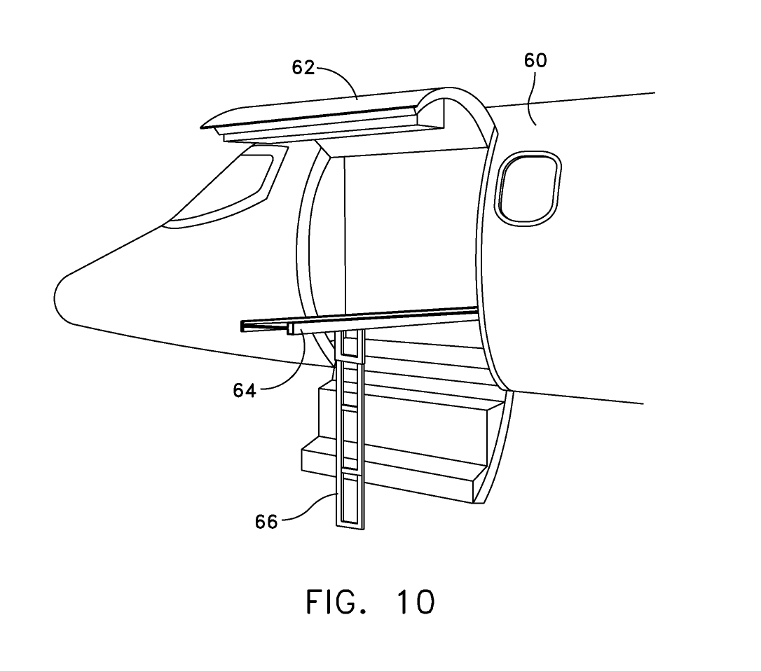

FIG. 10 is a perspective view of jet 60 having a horizontally extending ledge 64 substantially parallel to the ground, as implemented in the present invention. Ledge 64 extends from jet 60 and rests on adjuster 66. Adjuster 66 can be adjusted in a vertical manner. If adjuster 66 is adjusted upwardly, then ledge 64 will point upward in relation to the horizontal position depicted in FIG. 10. If adjuster 66 is adjusted downwardly, then ledge 64 will point downward in relation to the horizontal position depicted in FIG. 10. Adjuster 66 may be adjusted in accordance with the needs and desires of operators 55. Preferably, ledge 64 is adjusted to be horizontal, parallel to ground 68. This position allows for patient 54 to be shifted from top surface 4 of pneumatic lift 1 in the most simple and easy manner. As mentioned earlier, shifting the patient from pneumatic lift 1 to jet 60 can occur by a variety of methods. For instance, patient 54 can be slid, pushed, rolled into jet from pneumatic lift 1 onto ledge 64 and into jet 60, or, ledge 64 can further extend from jet 60 to slid under patient 54 and patient 54 can be brought, through the use of ledge 64, into jet by sliding of ledge 64.

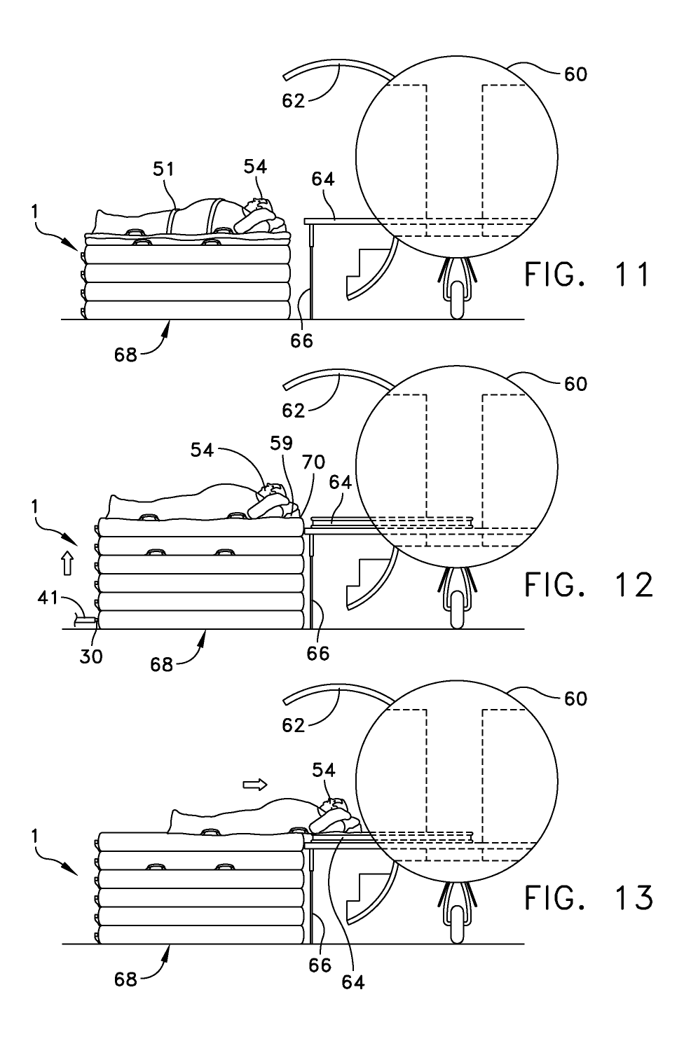

FIG. 11 is a side view of the implementation of the method of the present invention, showing patient 54 laying on pneumatic lift 1 in close proximity to jet 60. FIG. 11 portrays patient 54 laying at a height below the height of horizontally extending ledge 64. Patient 54 may optionally be secured to pneumatic lift 1 through the use of straps 51. As shown in FIG. 11, the preferred position of ledge 64 is parallel to ground 68.

FIG. 12 is a side view of the implementation of the method of the present invention, showing patient 54 having been raised to be laying parallel to ledge 64 extending horizontally from open door 62 of jet 60. FIG. 12 shows how patient 54 may be raised to be laying on top surface 4 of pneumatic lift 1 at a parallel to horizontally extending ledge 64. Patient 54 is raised by attaching air hose 41 to valve 34 and thereby flowing pressurized air into pneumatic lift 1. As more pressurized air is forced into jacking-mattress 3 of pneumatic lift 1, the distance between patient 54 and ground 68 increases. As shown in FIG. 12, the top portion of ledge 64 is preferably in direct alignment with lower portion 70 of pad 59. This allows for patient 54 to be shifted from pneumatic lift 1 onto horizontally extending ledge 64 in the most simple and least disruptive manner. Patient 54 may be lifted away from ground 68 by attaching air hose 41 to each jacking-mattress 3 at valve 34, and thereby increasing the pressure of each jacking-mattress 3, or, if each jacking-mattress 3 is in fluid communication with each other, this may be performed by attaching air hose 41 to valve 34 of the lower-most jacking-mattress 3, as shown in FIG. 1.

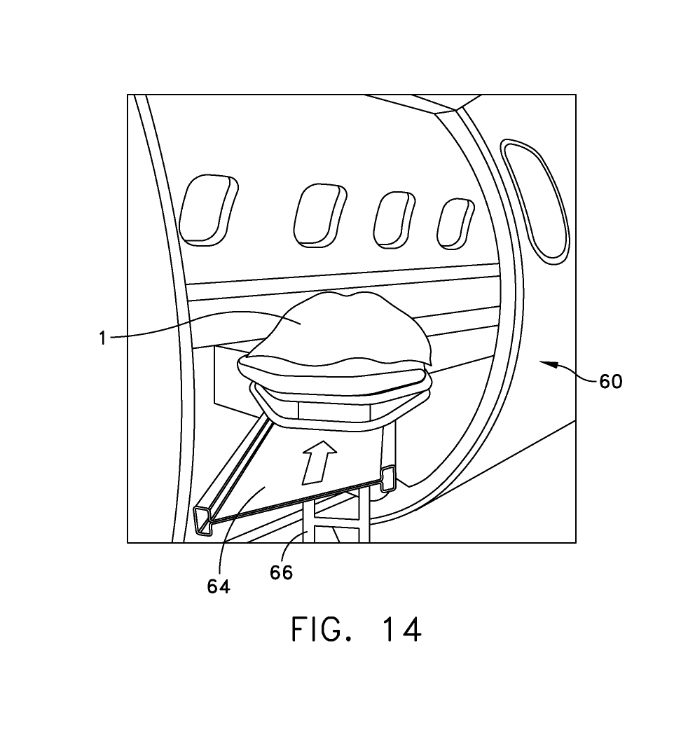

FIG. 13 is a side view of an exemplary implementation of the method of the present invention, showing patient 54 being shifted from pneumatic lift 1 onto ledge 64 and into jet 60. FIG. 13 portrays how patient 54 is shifted from pneumatic lift 1 into jet 60. As shown, patient 54 can be shifted in a steady, flat position without being bent, adjusted or placed at an angle. Air hose 41 has been removed from valve 34 and valve 34 has been closed in order to ensure the pressure of jacking-mattress(es) remains constant and pneumatic lift 1 remains at same height while patient 54 is shifted from top surface 4 to ledge 64, and finally into jet 60.

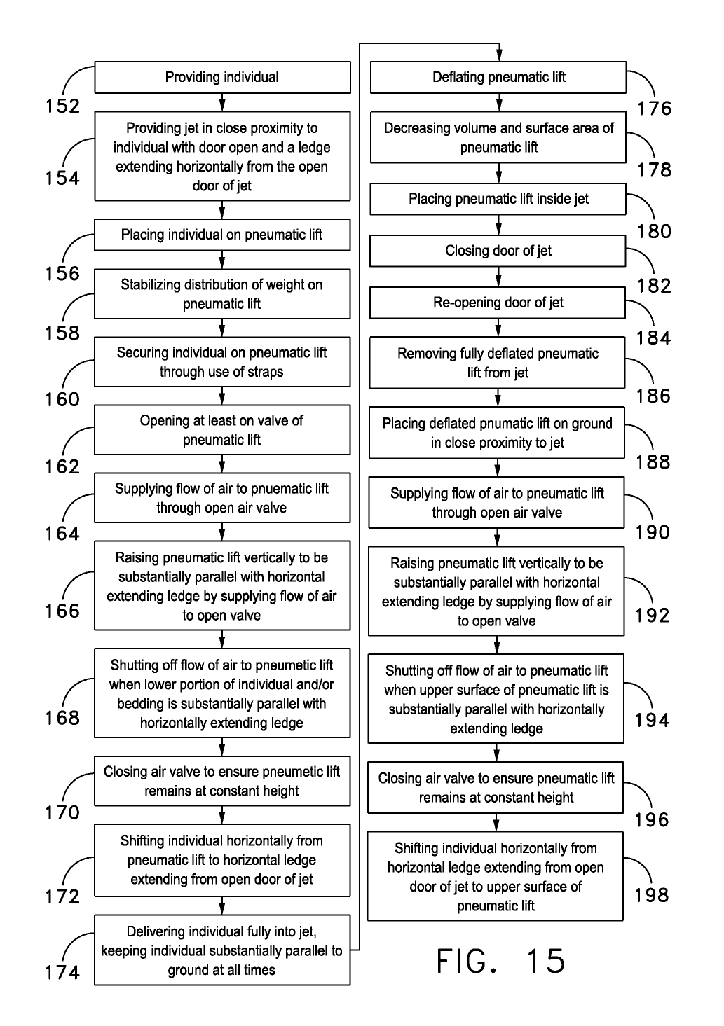

FIG. 14 is a perspective view of an exemplary implementation of the present invention, placing pneumatic lift 1 and ledge 64 inside of jet 60. After patient 54 is placed inside jet 60, ledge 64, adjuster 66, and pneumatic lift 1 are placed on an interior portion of jet 60. FIG. 14 shows how pneumatic lift 1 may be deflated and rolled, folded, or adjusted in some manner to decrease the surface area of pneumatic lift 1. Deflating pneumatic lift 1 allows for the pneumatic lift 1 to be placed in jet 60 without taking up the amount of space that would be necessary if pneumatic lift 1 could not be deflated.

FIG. 15 is a flow chart portraying steps of the present invention. Step 152 requires patient 54 to be present. Patient 54 may be an individual, an object, or anything that needs to be lifted from one location to another, or for example a higher location. Step 154 requires jet 60 to be provided in close proximity to patient 54 with an open door 62 and a ledge 64 extending horizontally from open door 62 of jet 60. Step 156 provides pneumatic lift 1, and patient 54 to be laying atop pneumatic lift 1. Pneumatic lift 1 may be in a fully deflated state, partially deflated, or fully inflated. In the preferred embodiment, pneumatic lift 1 is fully deflated and patient 54 is placed on pneumatic lift in its fully deflated state. This allows for patient 54 to be moved onto pneumatic lift 1 at a low point in relation to ground 68.

Optionally at step 158, operators 55 may stabilize the distribution of weight on pneumatic lift 1. This may require patient 54 to be moved in a certain direction, depending on the weight of patient 54. Step 160, also optional, provides that operators 55 may further stabilize patient 54 by securing patient 54 on pneumatic lift 1 through the use of straps 51. Securing patient 54 with straps 51 attached to buckles 53 will assist in keeping the weight of patient 54 distributed in a similar manner throughout the process of moving patient 54, and will also ensure patient 54 does not fall off pneumatic lift 1 during the process of moving patient 54. After patient 54 is successfully moved onto pneumatic lift 1 and secured, then one or more valves 34 may be opened. Step 164 requires connecting air hose 41 to one or more valves 34. Pressurized air is then forced into one or more jacking-mattresses 3 of pneumatic lift 1. Step 166 raises pneumatic lift 1 and thereby patient 54 in a vertical manner. Patient 54 is raised vertically through the flowing of pressurized air into jacking-mattresses 3 to be substantially parallel with horizontal extending ledge 64. Patient 54 is preferably raised vertically so that lower portion 70 of pad 59 is at substantially the same vertical height as the upper portion of horizontally extending ledge 64. This preferable position allows patient 54 to be shifted onto ledge 64 without bending or placing patient 54 at an angle.

At step 168 operator 55 shuts off air flow to pneumatic lift 1 as lower portion 70 of patient 54 or pad 59 is substantially parallel with horizontally extending ledge 64. At step 170 operator closes valve 34 to ensure pneumatic lift 1 remains at constant height. Patient 54 is shifted horizontally from pneumatic lift 1 to horizontal ledge 64 at step 172. Patient 54 is preferably shifted with emergency pad 59, allowing patient 54 to stay in proper alignment while being shifted from pneumatic lift 1 into jet 60. Patient 54 is then shifted into jet 60 at step 174, while preferably remaining in a horizontal position in relation to ground 68. Shifting of patient 54 may be performed by a variety of methods. Patient 54 may be rolled or picked up on emergency pad 59 by operators 55 to be shifted from pneumatic lift 1, to ledge 64, and finally to jet 60. In another embodiment, horizontally extending ledge 64 may extend from jet 60 to slide under patient 54, ledge 64 thereby being able to slide fully back into jet 60. After patient 54 is delivered into jet 60, pneumatic lift 1 is preferably fully deflated at step 176. At step 178 pneumatic lift 1 is optionally rolled, folded, bent, or manipulated in some manner as to decrease the surface area of pneumatic lift 1. Step 180 provides that pneumatic lift 1, ledge 64 and adjuster 66 are placed inside jet 60. At step 182, door 62 of jet 60 is closed and patient is transported to a desired location.

After being transported, patient 54 then needs to be removed from jet 60. At step 184, door 62 of jet 60 is re-opened and horizontally extending ledge 64 is placed to be extending from open door 62 in conjunction with adjuster 66. The deflated pneumatic lift 1 is then removed from jet 60 at step 186. At step 188 the deflated pneumatic lift 1 is placed on ground 68 in close proximity to jet 60. At step 190, air hose 41 is connected to valve 34 and pressurized air is again supplied to pneumatic lift 1 through one or more jacking mattresses 3. At step 192, pneumatic lift 1 is raised vertically to be substantially parallel with horizontally extending ledge 64 by supplying flow of pressurized air to valve 34. At step 194, the pressurized air is turned off when upper surface 4 of pneumatic lift 1 is substantially parallel with horizontally extending ledge 64. At step 196, valve 34 is closed after air hose 41 is removed, to ensure pneumatic lift 1 remains at constant height for patient 54 to be moved on to. At step 198, patient 54 is shifted horizontally from horizontal ledge 64 extending from jet 60 on to upper surface 4 of pneumatic lift 1.

It is to be understood that the present invention is by no means limited only to the particular constructions herein disclosed and shown in the drawings, but also comprises any modifications or equivalents within the scope of the claims.

What is claimed is:

1. A method of transferring a patient to jet, comprising:
providing a patient laying on top of a substantially deflated pneumatic lift adjacent to a jet having an open door and a ledge extending horizontally from said open door of said jet;
inflating said pneumatic lift, wherein said inflating raises said patient vertically;
shifting said patient from said pneumatic lift to said ledge extending horizontally from said open door of said jet.

2. The method of claim 1, further comprising:
deflating said pneumatic lift after shifting said patient onto said ledge.

3. The method of claim 2, further comprising:
placing said deflated pneumatic lift inside said jet.

4. The method of claim 1, further comprising:
providing a pad in between said patient and said pneumatic lift, wherein said patient is secured to said pad throughout the duration of the process.

5. The method of claim 4, wherein said shifting includes shifting said patient and said pad secured to said patient into said jet.

6. The method of claim 1, wherein said inflating includes inflating a plurality of jacking-mattresses, wherein said plurality of jacking-mattresses are separate from each other, and are not in fluid communication with each other.

7. The method of claim 1, wherein said shifting includes sliding said patient from said pneumatic lift to said horizontally extending ledge and sliding said horizontally extending ledge into said jet.

8. The method of claim 1, wherein after said step of shifting, further comprising:
deflating said pneumatic lift;
placing said deflated pneumatic lift inside said jet; and
closing said open door of said jet.

9. The method of claim 8, further comprising:
re-opening said door of said jet and extending said ledge horizontally from said open door of said jet;
placing said deflated pneumatic lift on the ground in close proximity to said open door of said jet; and
inflating said pneumatic lift, wherein the upper surface of said inflated pneumatic lift is substantially parallel with the upper surface of said horizontally extending ledge.

10. The method of claim 9, further comprising:
shifting said patient from the inside of said jet to the upper surface of said pneumatic lift.

11. The method of 10, wherein said shifting is performed by placing said patient on said horizontally extending ledge and sliding said horizontally extending ledge out of said jet toward said upper surface of said pneumatic lift.

12. The method of claim 1, wherein said shifting includes extending said ledge horizontally to slide under said patient, then with said patient laying on top of said ledge, sliding said ledge horizontally so that said patient and said ledge are fully inside said jet.

13. A method of transferring patient to jet, comprising:
providing a patient laying on a deflated pneumatic lift having at least one jacking-mattress;
providing a jet in close proximity to said patient laying on said deflated pneumatic lift, wherein said jet has an open door and a horizontally extending ledge protruding from said open door;
securing said patient on said pneumatic lift using at least one strap to tie down said patient on the upper surface of said pneumatic lift;
attaching an air hose to an open valve of said at least one jacking-mattresses;
supplying pressurized air to said open valve of said at least one jacking-mattress, thereby vertically raising said pneumatic lift;
shutting off said pressurized air flow when the lower portion of said patient is substantially parallel with said horizontally extending ledge protruding from said open door;
removing said air hose from said open valve;
closing said open valve;
shifting said patient horizontally from the upper surface of said pneumatic lift to said horizontally extending ledge protruding from said open door;
delivering said patient into said jet;
deflating said pneumatic lift;
placing said deflated pneumatic lift inside said jet;
closing said open door of said jet;
re-opening said door of said jet and re-placing said horizontally extending ledge to protrude outwardly from said open door of said jet;
removing said deflated pneumatic lift from said re-opened door of said jet;
placing said deflated pneumatic lift on the ground in close proximity to said jet;
supplying pressurized air to pneumatic lift through an open valve of said pneumatic lift, thereby raising said pneumatic lift vertically to be substantially parallel with said horizontally extending ledge protruding from said open door of said jet;
shutting off said pressurized air to pneumatic lift when the upper surface of said pneumatic lift is substantially parallel with horizontally extending ledge protruding from said open door of said jet;
closing said open valve of said pneumatic lift; and
shifting said patient horizontally from said horizontally extending ledge to the upper surface of said pneumatic lift.
